(19) United States
(12) Patent Application Publication
(10) Pub. No.: US 2009/0220760 A1
(43) Pub. Date: Sep. 3, 2009

(54) Ventilation material

(76) Inventor: Shi-Chuan Chen, Tantz Shiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/467,631

(22) Filed: May 18, 2009

Related U.S. Application Data
(63) Continuation-in-part of application No. 11/708,514, filed on Feb. 20, 2007.

(51) Int. Cl. B32B 7/02

(52) U.S. Cl. 428/217

(57) ABSTRACT

A ventilation structure as a material for manufacturing sheet of cloth, mat, footwear, mattress cover, etc, is disclosed that includes a lower layer of knitted fabric formed of a water-impermeable and water vapor-permeable fabric; an upper layer of knitted fabric formed of a water-impermeable and water vapor-permeable fabric; a plurality of support members formed between the upper and the lower layers; and a plurality of reticulated air ducts formed between the upper and the lower layers with the support members disposed thereamong. In one embodiment, the support members are shaped as triangle. Preferably, the support members are formed of plastic. In another embodiment, the hardness of a first portion of the support members is higher than that of the remaining portions of the support members. In yet another embodiment, the support members have a projecting portion contacting either the upper layer or the lower layer.

### CROSS REFERENCE TO RELATED PATENT APPLICATION

This patent application is a continuation-in-part (CIP) application of U.S. patent application Ser. No. 11/708,514 filed Feb. 20, 2007, for “Ventilation Material” that application is deemed entirely incorporated by reference herein for any purpose.

### BACKGROUND OF THE INVENTION

1. Field of Invention

The invention relates to ventilation materials and more particularly to a three-layer sheet-like article having an improved ventilation structure formed therein as a material for manufacturing sheet of cloth, mat, footwear, mattress cover, or the like.

2. Description of Related Art

Footwear, protective devices for athletes, mats, or mattress covers typically have a ventilation material formed therein for bringing a feeling of comfort to a person wearing same or lying or sitting thereon. A sheet of article having a conventional ventilation material formed therein is shown in FIGS. 7, 8 and 9. The sheet of article comprises a lower layer of knitted fabric 30 formed of a water-impermeable and water vapor-permeable fabric, an upper layer of knitted fabric 32 formed of a water-impermeable and water vapor-permeable fabric, and an intermediate layer of ventilation material 31 formed between the upper and lower layers 32 and 30. The layer of ventilation material 31 comprises a plurality of longitudinal apertures 311 arranged in parallel rows as air ducts.

It is designed to cause the sheet of article to have a ventilation effect. However, in fact, it is not true. In detail, the apertures 311 are too small to conduct sufficient air flow through the layers 30, 31, and 32. Further, the heat absorbing area of the layer of ventilation material 31 is relatively large. Thus, for example, a person wearing a pair of shoes having the layer of ventilation material 31 formed therein may feel a degree of discomfort and coldness. Furthermore, the layer of ventilation material 31 is an integral pad having the same stiffness in every portion. Thus, it is impossible of producing an article (e.g., a protective device for athlete) requiring some enhanced portions as protection by means of the well known ventilation material 31. Thus, the need for improvement still exists.

### SUMMARY OF THE INVENTION

It is therefore one object of the invention to provide a ventilation structure, comprising a lower layer of knitted fabric formed of a water-impermeable and water vapor-permeable fabric; an upper layer of knitted fabric formed of a water-impermeable and water vapor-permeable fabric; a plurality of first support members uniformly distributed formed between the upper and the lower layers, each first support member having a first hardness, each first support member having a polygonal first top surface and a polygonal first bottom surface; a plurality of second support members uniformly distributed formed between the upper and the lower layers, each second support member having a second hardness, the second hardness being higher than the first hardness, each second support member having a polygonal second top surface and a polygonal second bottom surface; and a plurality of reticulated air ducts formed between the upper and the lower layers with the support members disposed thereamong.

In one aspect of the invention the first support members and the second support members are shaped as triangle. Each first support member has a triangular first top surface and a triangular first bottom surface. Each second support member has a triangular second top surface and a triangular second bottom surface.

In another aspect of the invention the first support members and the second support members are shaped as hexagon. Each first support member has a hexagonal first top surface and a hexagonal first bottom surface. Each second support member has a hexagonal second top surface and a hexagonal second bottom surface.

In a further aspect of the invention the first support members and the second support members are formed of plastic.

In a yet further aspect of the invention the first support members and the second support members both have at least one projecting portion contacting either the upper layer or the lower layer.

The above and other objects, features and advantages of the invention will become apparent from the following detailed description taken with the accompanying drawings.

### BRIEF DESCRIPTION OF THE DRAWINGS

FIG. 1 is a perspective view of a sheet of article incorporating a preferred embodiment of ventilation material according to the invention;

FIG. 2 is a partially broken away view of FIG. 1;

FIG. 3 is a longitudinal sectional view of an enlarged portion of FIG. 1;

FIG. 4 is a partially broken away view of another preferred embodiment of ventilation material;

FIG. 5 is a perspective view of a sheet of article incorporating a preferred embodiment of ventilation material;

FIG. 6 is a side view of a sheet of article incorporating a preferred embodiment of ventilation material when in use;

FIG. 7 is a perspective view of a sheet of article having a conventional ventilation material formed therein;

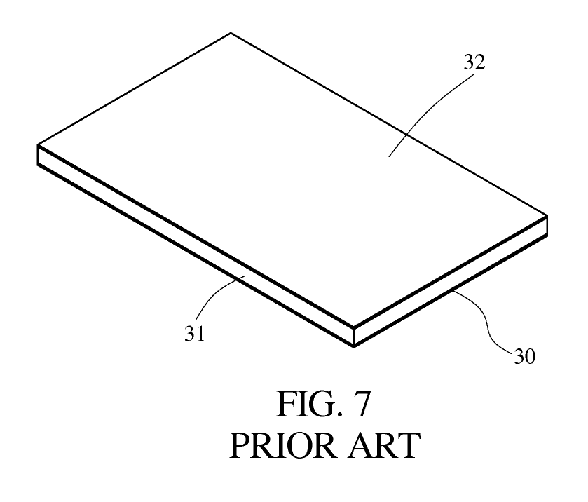

FIG. 8 is an exploded view of FIG. 7; and

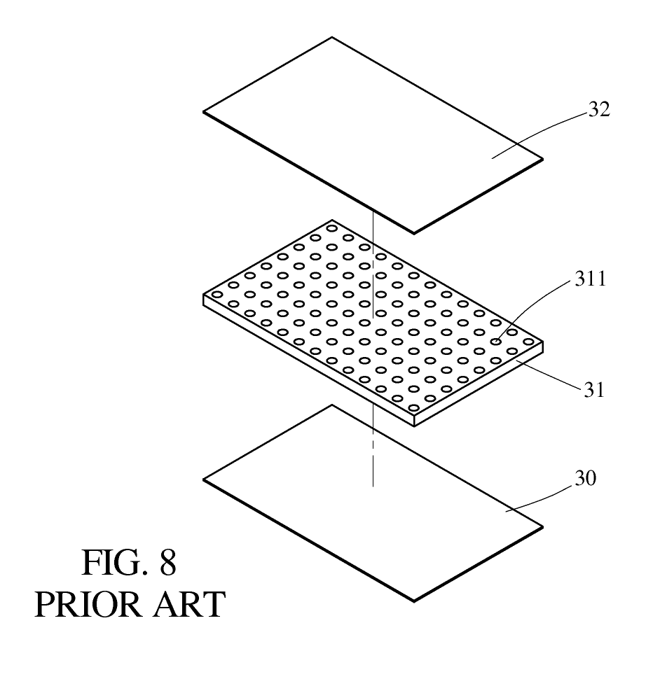

FIG. 9 is a longitudinal sectional view of an enlarged portion of FIG. 7.

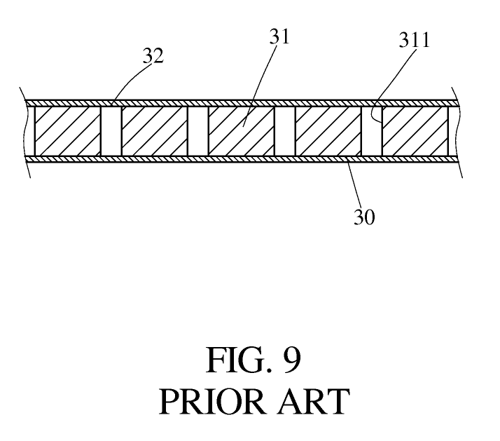

### DETAILED DESCRIPTION OF THE INVENTION

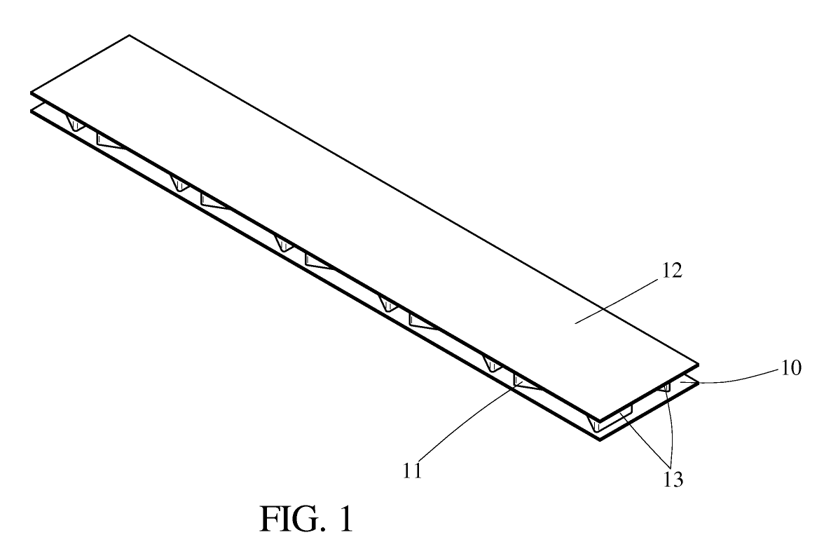

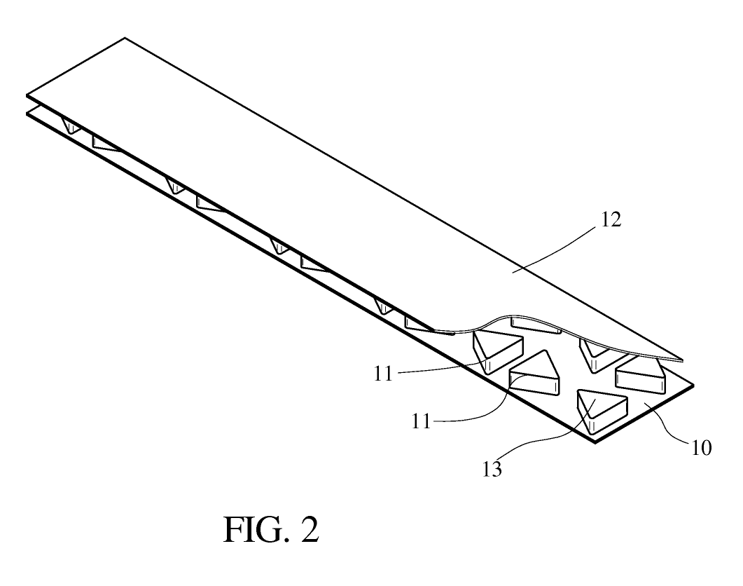

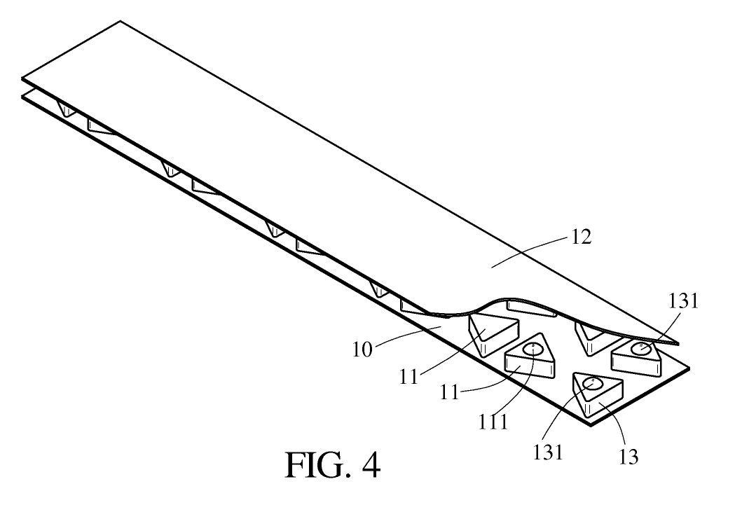

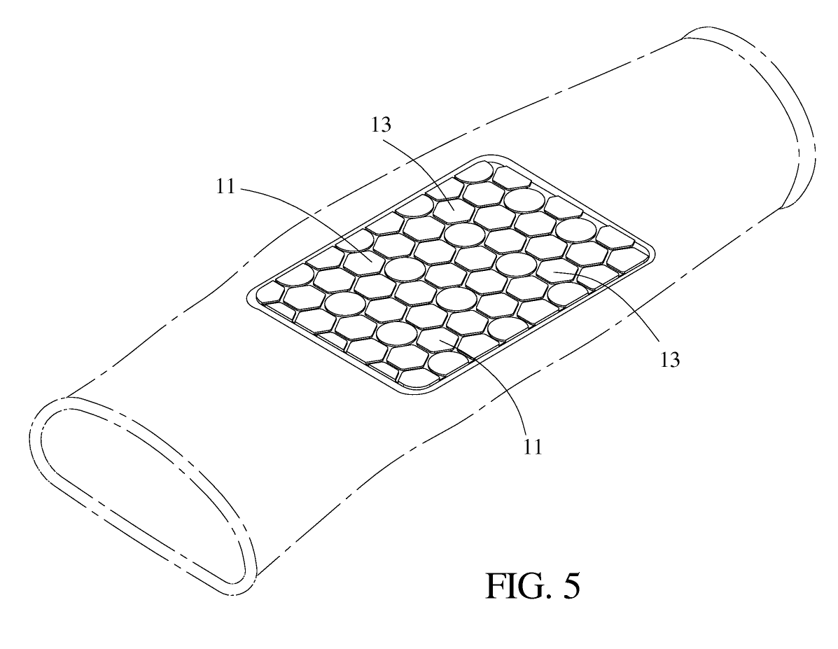

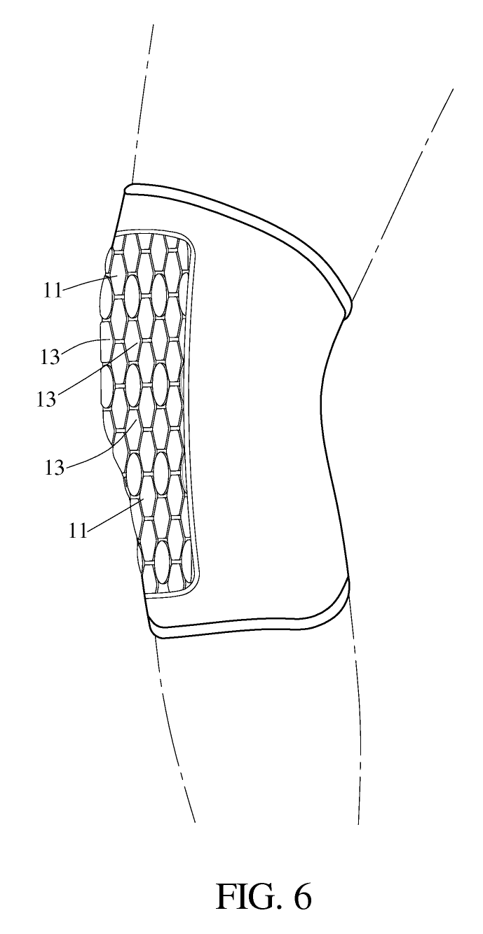

Referring to FIGS. 1 to 6, a sheet of article incorporating a preferred embodiment of ventilation material according to the invention is shown. The sheet of article comprises a lower layer of knitted fabric 10 formed of a water-impermeable and water vapor-permeable fabric, an upper layer of knitted fabric 12 formed of a water-impermeable and water vapor-permeable fabric, and a plurality of first support members 11 uniformly distributed formed between the upper and the lower layers 12 and 10. Each first support member 11 has a first hardness and each first support member 11 has a polygonal first top surface and a polygonal first bottom surface, and a plurality of second support members 13 uniformly distributed formed between the upper and the lower layers 12 and 10. Each second support member 13 has a second hardness and the second hardness is higher than the first hardness. Each second support member 13 has a polygonal second top surface and a polygonal second bottom surface. Preferably, the first support members 11 and the second support members 13 are formed of plastic. Further, shape of the first support members 11 and the second support members 13 other than triangle and hexagon is contemplated by the invention. In addition, stiffness of the first support members 11 may be different from that of the second support members 13 depending on applications. For example, stiffness enhancement of some portions of a protective device for athlete made of the sheet of article is desired. As shown in FIG. 2, one side of the first support member 11 of one row is parallel with one side of another first support member 11 of an adjacent row. Note that the orientation of the first support members 11 other than above is also contemplated by the invention.

Preferably, the first support members 11 and the second support members 13 are shaped as triangle. Each first support member 11 has a triangular first top surface and a triangular first bottom surface. Each second support member 13 has a triangular second top surface and a triangular second bottom surface.

Preferably, the first support members 11 and the second support members 13 are shaped as hexagon. Each first support member 11 has a hexagonal first top surface and a hexagonal first bottom surface, each second support member 13 has a hexagonal second top surface and a hexagonal second bottom surface.

Preferably, the first support members 11 and the second support members 13 both have at least one projecting portion 111 contacting either the upper layer 12 or the lower layer 10.

Referring to FIG. 2, the ventilation material of the present invention utilizes foamed plastic materials, in the manufacture process, to create the geometric support members 11 and 13. First, a sheet of foamed plastic is subjected to a cutting machine that cuts the foamed plastic material to a desired thickness. Second, once the foamed plastic material is prepared to the desired thickness, a second cutting tool cuts the foamed plastic, in a cookie cutter fashion, to create support members 11 and 13 of the desired geometric shape. Third, the excess material present between the cut geometric shapes is removed leaving individual geometric support members 11 and 13. Finally, as seen in FIG. 2, the individual geometric support members 11 and 13 are adhered to the upper surface of the lower layer 10 and the lower surface of the upper layer 12. The disclosed configuration creating a sandwich configuration with the support members 11 and 13 disposed between the upper and lower layers 12 and 10. The adhesives appropriate for such applications are well known in the art. The materials employed to create the upper layer 12 and the lower layer 10.

The present invention utilizes different raw materials and different foamed plastics to form the support members 11 and 13 of different hardness, such as PE (Polyethylene), EVA (Ethylene Vinyl Acetate Copolyn) or TPE (Thermoplastic elastomer rubber). According to the different needs, the support members 11 and 13 have different hardness. For example, a number of the second support members 13 designed to protect is harder than another number of the first support members 11. Moreover, the present invention shows better deformation and fits well to the body of the user owing to the plurality of the support members 11 and 13.

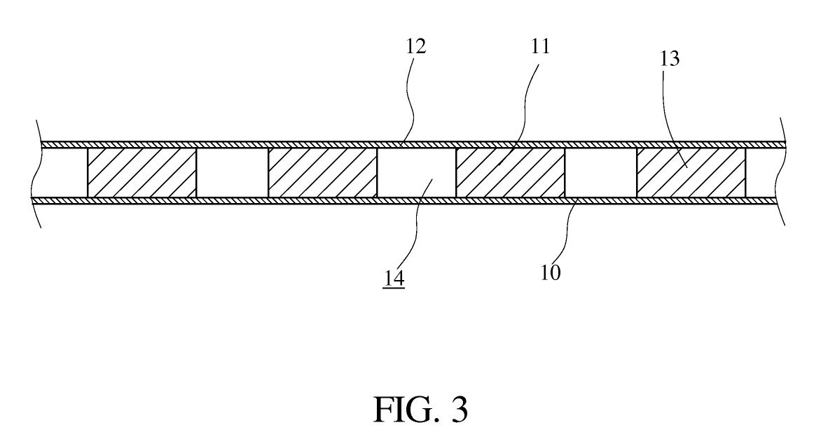

Referring to FIG. 3 specifically, a plurality of air ducts 14 are formed between the layers 10 and 12. Also, the air ducts 14 are reticulated with the support members 11 and 13 disposed among them. Advantageously, a total space occupied by the air ducts 14 is sufficiently large. Thus, the desired ventilation effect can be achieved by conducting air flow through the lower layer 10, the air ducts 14, and the upper layer 12. Hence, for example, a person wearing a pair of shoes having the intermediate Support members 11 formed therein may feel a degree of comfort. Additionally, padding material such as foam can be placed in some air ducts 14 for increasing the shock absorbing capability of the sheet of article without adversely affecting the ventilation effect.

In one application, a mat incorporating the support members 11 and 13 with thus formed air ducts 14 can be placed on a sheet of cloth. Thereafter, person(s) may sit on the mat. Advantageously, the mat can bring a degree of comfort to the person(s) sitting thereon.

Alternatively, the first support members 11 and the second support members 13 have a projecting portion 111 and 131 contacting either the upper layer 12 or the lower layer 10 such that a massaging effect to the corresponding body portion is carried out when a person sits on, for example, a mat having the support members 11 and 13 formed therein.

The support members 11 and 13 have different hardness. Additionally, the rigidity of some support members 11 are different from that of the remaining support members 13 depending on applications. For example, rigidity enhancement may be appropriate for some portions of a protective device for athletics. The air ducts 14 are reticulated with the supporting members 11 and 13 disposed among them.

While the invention herein disclosed has been described by means of specific embodiments, numerous modifications and variations could be made thereto by those skilled in the art without departing from the scope and spirit of the invention set forth in the claims.

What is claimed is:

1. A ventilation structure, comprising:
a lower layer of knitted fabric formed of a water-impermeable and water vapor-permeable fabric;
an upper layer of knitted fabric formed of a water-impermeable and water vapor-permeable fabric;
a plurality of first support members uniformly distributed formed between the upper and the lower layers, each first support member having a first hardness, each first support member having a polygonal first top surface and a polygonal first bottom surface;
a plurality of second support members uniformly distributed formed between the upper and the lower layers, each second support member having a second hardness, the second hardness being higher than the first hardness, each second support member having a polygonal second top surface and a polygonal second bottom surface; and
a plurality of reticulated air ducts formed between the upper and the lower layers with the first support members and the second members disposed thereamong; the first support members and the second support members are formed of plastic; the first support members and the second support members both have at least one projecting portion contacting either the upper layer or the lower layer.

2. The ventilation structure of claim 1, wherein the first support members and the second support members are shaped as triangles, each first support member having a triangular first top surface and a triangular first bottom surface, each second support member having a triangular second top surface and a triangular second bottom surface.

3. The ventilation structure of claim 1, wherein the first support members and the second support members are shaped as hexagons, each first support member having a hexagonal first top surface and a hexagonal first bottom surface, each second support member having a hexagonal second top surface and a hexagonal second bottom surface.
